(19) United States
(12) Patent Application Publication
(10) Pub. No.: US 2025/0347619 A1
(43) Pub. Date: Nov. 13, 2025

(54) Method for remote detection of gaseous substances in the atmosphere by the DIAL system with two lasers and a remote detector

(71) Applicant: SEC TECHNOLOGIES, S.R.O., Liptovsky Mikulas (SK)

(72) Inventors: Jiri Vicenik, Liptovsky Mikulas (SK); Zina SEDLACKOVA, Liptovsky Mikulas (SK)

(21) Appl. No.: 19/276,840

(22) Filed: Jul. 22, 2025

Related U.S. Application Data
(63) Continuation of application No. 17/917,154, filed on Oct. 5, 2022, now Pat. No. 12,392,716.

(30) Foreign Application Priority Data
Apr. 7, 2020 (SK) PP 35-2020
Apr. 7, 2020 (SK) PUV 49-2020

(51) Int. Cl. G01N 21/3504; G01N 21/17; G01N 21/39

(52) U.S. Cl. CPC G01N 21/3504; G01N 21/39; G01N 2021/1755; G01N 2021/1795; G01N 2021/394

(57) ABSTRACT

A system and method for remote detection of gaseous substances by a DIAL system includes causing a laser beam generated by a first laser to impinge on a semipermeable mirror, wherein 50% of the laser beam power passes through the semipermeable mirror and proceeds through a first aperture towards a target, wherein a remaining 50% of the laser beam power reflects from the semipermeable mirror and impinges on a reflecting mirror from which it is reflected. The method may also include causing a delayed laser beam generated by a second laser to impinge on the semipermeable mirror, wherein 50% of the laser beam power passes through the semipermeable mirror and impinges on the reflecting mirror from which it is reflected and is directed through the second aperture to the target and at the same time a remaining 50% of the laser beam power reflects from the semipermeable mirror.

### RELATED APPLICATIONS

This application claims priority to, and is a continuation application of, U.S. patent application Ser. No. 17/917,154, filed on Oct. 5, 2022, which is a National Stage Application of International Patent Application PCT/SK2021/000002, filed Apr. 7, 2021, which claims priority to Slovakia Patent Application No. PP 35-2020, filed Apr. 7, 2020, and to Slovakia Patent Application No. PUV 49-2020, filed Apr. 7, 2020, all of which are hereby incorporated by reference in their entirety.

### TECHNICAL FIELD

The invention relates to a method for the remote detection of gaseous substances in the atmosphere by a DIAL system with two lasers and to the construction of a remote detector of gaseous substances in the atmosphere using the DIAL (Differential Absorption LIDAR) technology with two lasers. The invention falls within the field of laser systems.

### BRIEF DESCRIPTION OF THE DRAWINGS

FIG. 1 illustrates a device that may utilize the disclosed method for remote detection of gaseous substances in the atmosphere by the DIAL system with two lasers and a remote detector of gaseous substances in the atmosphere according to the invention is shown in the FIGURE of the accompanying drawing.

### BACKGROUND OF THE INVENTION

The so-called “classic” arrangement of the DIAL system with two lasers has a single output aperture, where the laser beams from both lasers are merged by means of a semipermeable mirror so that they are coaxial. Therefore, the laser radiation from both lasers propagates towards the target-object that ends a particular measuring route, through the identical volume of the atmosphere. The obvious disadvantage of this arrangement is the 50% loss of energy from the lasers arising from the merging of beams (although this 50% of energy is used to synchronize the system and measure outgoing energies) which has a negative effect on the remote detector range, as its range drops to about 70%. If the output aperture is accidentally blocked, such DIAL system fails.

There is a DIAL system arrangement with two lasers and two output apertures, where each laser has a separate output aperture. In practice, there are for instance the DD-CWA and the F4G systems operating on this basis. As a result, the laser radiation from one laser propagates to the target to a certain distance through a different volume of the atmosphere than the radiation from the other laser. The laser beams gradually overlap, but they usually get coincident to about 50% on a halfway towards the target. The influence of optical atmospheric effects, the different aerosol content and also the different concentrations of the detected substance for one and the other laser in the initial part of the measuring route can fundamentally negatively affect the minimum detectable concentration. If one of the output apertures of such DIAL is accidentally blocked for a short period of time, it may either cause false detection or prevent the detection of the real cloud of substance to be detected.

### SUMMARY OF THE INVENTION

The method for remote detection of gaseous substances in the atmosphere by the DIAL system with two lasers according to the invention largely eliminates these drawbacks, the essence of which consists in that the laser beam generated by the first laser impinges on a semipermeable mirror, where 50% of the laser beam power passes through the semipermeable mirror and proceeds through the first aperture towards the target and at the same time the remaining 50% of the laser beam power reflects from the semipermeable mirror, impinges on a totally reflecting mirror from which it is reflected and is directed through the second aperture to the same target. The delayed laser beam generated by the second laser impinges on the semipermeable mirror, where 50% of the laser beam power passes through the semipermeable mirror, impinges on the totally reflecting mirror from which it is reflected and is directed through the second aperture to the same target and at the same time the remaining 50% of the laser beam power reflects from the semipermeable mirror and proceeds through the first aperture towards the same target.

In essence, the laser beams from both lasers are merged by a semipermeable mirror, each beam being divided into two, each carrying 50% of the energy from the first and then also the second laser, and both beams are directed in parallel, one by semipermeable and the other one by totally reflecting mirror to the target.

The above stated method for remote detection of gaseous substances in the atmosphere by the DIAL system with two lasers is usable in a remote detector of gaseous substances in the atmosphere according to the invention, the essence of which is based on the presence of the first laser and the second laser, while at the intersection of the axes of their laser beams a semipermeable mirror is located. Behind the semipermeable mirror, a totally reflecting mirror is located in the forward direction of the laser beam advance generated by the second laser and also in the reflected direction from the semipermeable mirror of the laser beam advance generated by the first laser. The first aperture is located in a forward direction from the semipermeable mirror of the 50% laser beam advance from the first laser and of the reflected 50% laser beam advance from the second laser. The second aperture is located in the reflected direction from the totally reflecting mirror of the 50% laser beam advance from the first laser and of the 50% laser beam advance from the second laser.

The advantages of the method for remote detection of gaseous substances in the atmosphere by the DIAL system with two lasers and the construction of the remote detector of gaseous substances in the atmosphere according to the invention are evident from the effects which are manifested externally. The originality of the solution lies in the fact that by merging beams from both lasers using semipermeable mirror and at the same time by dividing each beam into two, each carrying 50% of energy from the first and then also the second laser, where both beams are directed in parallel to the target, there is no 50% loss of energy of lasers and therefore no decrease in the range of the DIAL and laser radiation from both lasers passes through the same volumes of atmosphere. Such arrangement of the DIAL system with two lasers with the division of laser beams into two minimizes the external influences of atmospheric effects on detection and ensures the maximum detection range. The solution with two output apertures brings other advantages here. One advantage is that even if one of the apertures is completely blocked, the range of the system will decrease, but the detection capability and DIAL sensitivity will be preserved. The second advantage is that division the laser beams into two will bring the power density reduction in the output apertures and thus vision safety increase, because although the total energy coming from the aperture remains approximately the same, it is divided into two pulses: the first from the first laser, and after a significant delay the second from the second laser.

### Example of Embodiment

In this example of a specific embodiment of the subject of the invention, a solution of a method for remote detection of gaseous substances in the atmosphere by the DIAL system with two lasers according to the invention is described. The method for remote detection is applied to a remote detector of gaseous substances in the atmosphere. It is based on the fact that the laser beam generated by the first laser impinges on a semipermeable mirror, where 50% of the laser beam power passes through the semipermeable mirror and proceeds through the first aperture towards the target and at the same time the remaining 50% of the laser beam power reflects from the semipermeable mirror, impinges on a totally reflecting mirror from which it is reflected and is directed through the second aperture to the same target. The delayed laser beam generated by the second laser impinges on a semipermeable mirror, where 50% of the laser beam power passes through the semipermeable mirror, impinges on a totally reflecting mirror from which it is reflected and is directed through the second aperture to the same target and at the same time the remaining 50% of the laser beam power reflects from the semipermeable mirror and proceeds through the first aperture towards the same target.

In this example of a specific embodiment of the subject of the invention, a solution of a method for remote detector of gaseous substances in the atmosphere according to the invention is described, which is shown in the FIGURE. It consists of the first laser 1 and the second laser 2, while at the intersection of the axes of their laser beams a semipermeable mirror 3 is located. Behind the semipermeable mirror 3, a totally reflecting mirror 5 is located in the forward direction of the laser beam advance generated by the second laser 2 and also in the reflected direction from the semipermeable mirror 3 of the laser beam advance generated by the first laser 1. The first aperture 4 is located in a forward direction from the semipermeable mirror 3 of the 50% laser beam advance from the first laser 1 and of the reflected 50% laser beam advance from the second laser 2. The second aperture 6 is located in the reflected direction from the totally reflecting mirror 5 of the 50% laser beam advance from the first laser 1 and of the 50% laser beam advance from the second laser 2. The device is complemented by a receiver 7 of reflected laser beams.

### INDUSTRIAL USABILITY

The method for remote detection of gaseous substances in the atmosphere by the DIAL system with two lasers and a remote detector of gaseous substances in the atmosphere are usable in laser technology applications.

The method for remote detection of gaseous substances in the atmosphere by the DIAL system with two lasers is based on the fact that the laser beam generated by the first laser impinges on a semipermeable mirror, where 50% of the laser beam power passes through the semipermeable mirror and proceeds through the first aperture towards the target and at the same time the remaining 50% of the laser beam power reflects from the semipermeable mirror, impinges on a totally reflecting mirror from which it is reflected and is directed through the second aperture to the same target. The delayed laser beam generated by the second laser impinges on a semipermeable mirror, where 50% of the laser beam power passes through the semipermeable mirror, impinges on a totally reflecting mirror from which it is reflected and is directed through the second aperture to the same target and at the same time the remaining 50% of the laser beam power reflects from the semipermeable mirror and proceeds through the first aperture towards the same target.

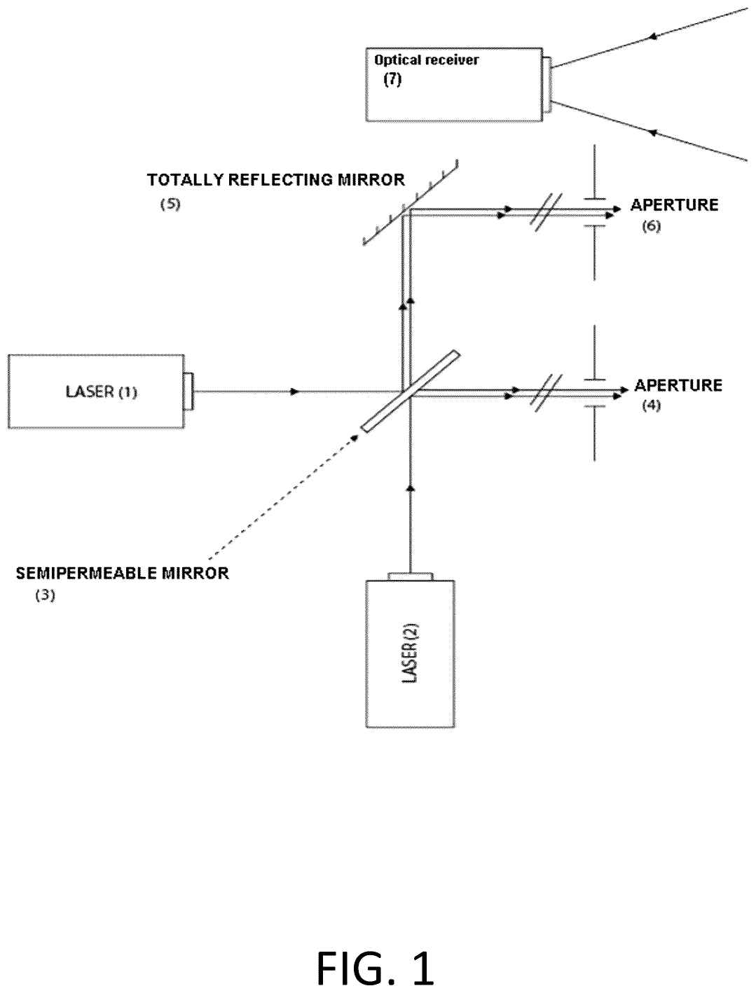

With respect to FIG. 1, the remote detector of gaseous substances in the atmosphere by the DIAL system with two lasers consists of the first laser (1) and the second laser (2), while at the intersection of the axes of their laser beams a semipermeable mirror is located (3). Behind the semipermeable mirror (3), a totally reflecting mirror (5) is located in the forward direction of the laser beam advance generated by the second laser (2) and also in the reflected direction from the semipermeable mirror (3) of the laser beam advance generated by the first laser (1). The first aperture (4) is located in a forward direction from the semipermeable mirror (3) of the 50% laser beam advance from the first laser (1) and of the reflected 50% laser beam advance from the second laser (2). The second aperture (6) is located in the reflected direction from the totally reflecting mirror (5) of the 50% laser beam advance from the first laser (1) and of the 50% laser beam advance from the second laser (2).

1. A device comprising:
a first laser associated with a differential absorption LIDAR (DIAL) system;
a second laser associated with the DIAL system;
a semipermeable mirror associated with the DIAL system disposed at least partially at a convergence of axes of a first laser beam from the first laser and a second laser beam from the second laser;
a reflecting mirror associated with the DIAL system disposed at least partially behind the semipermeable mirror and located in a forward direction of the second laser beam in a reflected direction from the semipermeable mirror of the first laser beam;
a first aperture associated with the DIAL system disposed in a forward direction from the semipermeable mirror such that a first portion of the first laser beam passes through the semipermeable mirror and impinges on the reflecting mirror and a second portion of the second laser beam is reflected; and
a second aperture associated with the DIAL system disposed in the reflected direction such that the first portion and the second portion are reflected, wherein the first aperture and the second aperture are configured to detect a gaseous substance.

2. The device of claim 1, further comprising a receiver configured to receive the first portion and the second portion and to analyze spectral characteristics of the first portion and the second portion to identify the gaseous substance.

3. The device of claim 1, wherein the first laser and the second laser are configured to operate at different wavelengths to enable differential absorption measurements of the gaseous substance.

4. The device of claim 1, wherein the second laser is configured to generate a delayed laser beam relative to the first laser to optimize detection of the gaseous substance.

5. The device of claim 1, wherein the device is configured to maintain gaseous substance detection capabilities when at least one of the first aperture or the second aperture is at least partially blocked.

6. A method for remote detection of gaseous substances comprising:
causing a laser beam to at least partially impinge on a semipermeable mirror, wherein:
a first portion of the laser beam passes through the semipermeable mirror and proceeds through a first aperture towards a target, and
a second portion of the laser beam reflects from the semipermeable mirror and impinges on a reflecting mirror which redirects the second portion through a second aperture toward the target;
causing a delayed laser beam to impinge on the semipermeable mirror, wherein:
a third portion of the delayed laser beam passes through the semipermeable mirror and impinges on the reflecting mirror which redirects the third portion through the second aperture to the target; and
a fourth portion of the delayed laser beam reflects from the semipermeable mirror and proceeds through the first aperture towards the target; and
detecting, based at least in part on causing the delayed laser beam to impinge on the semipermeable mirror, a gaseous substance.

7. The method of claim 6, further comprising receiving a reflected portion of at least one of the laser beam or the delayed laser beam and analyzing a spectral characteristic of the reflected portion to identify the gaseous substance.

8. The method of claim 6, wherein the laser beam is generated by a first laser operating at a first wavelength and the delayed laser beam is generated by a second laser operating at a second wavelength different than the first wavelength, wherein a difference between the first wavelength and the second wavelength enables differential absorption measurements of the gaseous substance.

9. The method of claim 6, further comprising positioning a first laser configured to generate the laser beam and a second laser configured to generate the delayed laser beam with respect to each other such that an intersection of axes of the laser beam from the first laser and the delayed laser beam from the second laser includes the semipermeable mirror.

10. The method of claim 6, further comprising directing the first portion, the second portion, the third portion, and the fourth portion in parallel paths toward the target to cause laser radiation to pass through substantially identical volumes of atmosphere.

11. The method of claim 6, wherein the method maintains gaseous substance detection capabilities when at least one of the first aperture or the second aperture is at least partially blocked.

12. The method of claim 6, further comprising reducing a first power density at the first aperture and a second power density at the second aperture by dividing the laser beam and the delayed laser beam into separate pulses to increase vision safety.

13. One or more non-transitory computer-readable media storing instructions executable by one or more processors, wherein the instructions, when executed, cause the one or more processors to perform operations comprising:
causing a laser beam to at least partially impinge on a semipermeable mirror, wherein:
a first portion of the laser beam passes through the semipermeable mirror and proceeds through a first aperture towards a target, and
a second portion of the laser beam reflects from the semipermeable mirror and impinges on a reflecting mirror which redirects the second portion through a second aperture toward the target;
causing a delayed laser beam to impinge on the semipermeable mirror, wherein:
a third portion of the delayed laser beam passes through the semipermeable mirror and impinges on the reflecting mirror which redirects the third portion through the second aperture to the target; and
a fourth portion of the delayed laser beam reflects from the semipermeable mirror and proceeds through the first aperture towards the target; and
detecting, based at least in part on causing the delayed laser beam to impinge on the semipermeable mirror, a gaseous substance.

14. The one or more non-transitory computer-readable media of claim 13, the operations further comprising:
receiving a fifth portion of at least one of the laser beam or the delayed laser beam; and
analyzing a spectral characteristic of the fifth portion to identify the gaseous substance.

15. The one or more non-transitory computer-readable media of claim 13, the operations further comprising a first laser associated with the laser beam and a second laser associated with the delayed laser beam, the operations further comprising configuring the first laser to operate the laser beam at a first wavelength and the second laser to operate the delayed laser beam at a second wavelength different than the first wavelength, wherein a difference between the first wavelength and the second wavelength enables differential absorption measurements of the gaseous substance.

16. The one or more non-transitory computer-readable media of claim 13, wherein a device associated with the one or more processors is configured to maintain gaseous substance detection capabilities when at least one of the first aperture or the second aperture is at least partially blocked.

17. The one or more non-transitory computer-readable media of claim 13, the operations further comprising reducing a first power density of the first aperture and second power density of the second aperture by dividing the laser beam and the delayed laser beam into separate pulses to increase vision safety.

18. The one or more non-transitory computer-readable media of claim 13, the operations further comprising directing the first portion and the second portion in a parallel path toward the target to cause laser radiation to pass through substantially identical volumes of atmosphere.

19. The one or more non-transitory computer-readable media of claim 13, the operations further comprising positioning a first laser configured to cause the laser beam and a second laser configured to cause the delayed laser beam relative to each other such that a first axis of the laser beam and a second axis of the delayed laser beam intersect at the semipermeable mirror.

20. The one or more non-transitory computer-readable media of claim 13, the operations further comprising causing a division of the laser beam based at least in part on providing a power to the laser beam such that the first portion and the second portion are substantially similar, wherein causing the division is configured to minimize an external influence of atmospheric effects on detection of the gaseous substance.
